(19) United States
(12) Patent Application Publication
(10) Pub. No.: US 2005/0175742 A1
(43) Pub. Date: Aug. 11, 2005

(54) Method and apparatus for packaging foodstuffs

(76) Inventors: Mark Kornely, Two Rivers, WI (US); Michael Yauger, Mishicot, WI (US); Paul Becker, Two Rivers, WI (US); Mark Laux, Oshkosh, WI (US); Dean Morgan, Two Rivers, WI (US); Randall Hallada, Two Rivers, WI (US); Paul Scheffell, Two Rivers, WI (US)

Correspondence Address: MICHAEL BEST & FRIEDRICH, LLP, 100 E WISCONSIN AVENUE, MILWAUKEE, WI, 53202, US

(21) Appl. No.: 10/777,029

(22) Filed: Feb. 11, 2004

(51) Int. Cl. C12C 1/027

(52) U.S. Cl. 426/106

(57) ABSTRACT

A method and apparatus for packaging foodstuffs and a package of foodstuffs. The package has a minimum predetermined overall weight and includes a first foodstuff having a first minimum predetermined component weight and a second foodstuff having a second minimum predetermined component weight. The first and second foodstuffs are designed to be cooked together for a single cooking time such that the first and second foodstuffs are both cooked substantially to completion without degrading the quality of the first and second foodstuffs.

### FIELD OF THE INVENTION

The invention relates to foodstuffs, and more particularly to a method and apparatus for packaging foodstuffs.

### BACKGROUND OF THE INVENTION

Many businesses in the food service industry sell certain foodstuffs, commonly called appetizers, to consumers for consumption. Often, these appetizers are sold to the end consumer in individual portions of a single type of appetizer. Additionally, many restaurants now offer combination platters having a variety of different types of appetizers in a single serving to appease the different tastes of multiple people who may be dining together. However, preparing the combination platters can be time consuming and difficult as each different type of appetizer is stored separately, often requires a different cook time, and often requires a different cook temperature.

### SUMMARY OF THE INVENTION

The present invention provides a package of foodstuffs having a minimum predetermined overall weight. The package includes a first foodstuff having a first composition and a first minimum predetermined component weight, and a second foodstuff having a second composition and a second minimum predetermined component weight. The first and second foodstuffs are designed to be cooked together for a single cooking time such that the first and second foodstuffs are both cooked substantially to completion without degrading the quality of the first and second foodstuffs.

The invention also provides a method of packaging foodstuffs. The method includes delivering a first quantity of a first foodstuff to a weighing area and delivering a second quantity of a second foodstuff to the weighing area. The method further includes weighing the first and second foodstuffs individually and in combination, and placing the first and second foodstuffs in a single package such that the single package has a minimum predetermined overall weight, a minimum predetermined component weight of the first foodstuff, and a minimum predetermined component weight of the second foodstuff.

The invention also provides a method of preparing foodstuffs for consumption. The method includes providing a package containing a single serving of foodstuffs, the foodstuffs including a plurality of different types of foodstuffs having different compositions, and the package having a minimum predetermined overall weight and a minimum predetermined component weight of each of the plurality of different types of foodstuffs. The method further includes placing the foodstuffs in a cooking device and cooking the single serving of foodstuffs together for a single cook time such that all of the different types of foodstuffs are cooked substantially to completion while maintaining the quality of the foodstuffs.

The invention also provides an apparatus for combining and packaging different types of foodstuffs. The apparatus includes a plurality of loading stations and a conveyor in communication with the loading stations. The apparatus also includes a scale assembly in communication with the conveyor. The scale assembly includes a plurality of weighing mechanisms for weighing the different types of foodstuffs individually to achieve minimum predetermined component weights for each of the different types of foodstuffs, and a control system operable to combine the minimum individual component weights of the different types of foodstuffs to achieve a minimum predetermined overall weight. The apparatus also includes a packaging station in communication with the scale assembly for receiving and packaging the weighed foodstuffs.

Other features and advantages of the invention will become apparent to those skilled in the art upon review of the following detailed description, claims, and drawings.

### BRIEF DESCRIPTION OF THE DRAWINGS

FIG. 1 is a side view of an apparatus for packaging foodstuffs according to the present invention.

FIG. 2 is a perspective view of a package of foodstuffs made according to the invention.

FIG. 3 is a top view of the apparatus of FIG. 1.

FIG. 4 is a top view of loading stations of the apparatus of FIG. 1.

FIG. 5 is a partial top view of a portion of the apparatus of FIG. 1.

FIG. 6 is a front view of a scale assembly and packaging station of the apparatus of FIG. 1.

FIG. 7 is a perspective view of a portion of the scale assembly of FIG. 6, illustrating a disbursement table and a plurality of radial feeders.

FIG. 8 is a perspective view of another portion of the scale assembly of FIG. 6, illustrating the pooling hoppers, the weighing buckets, and the collection hoppers.

FIG. 9 is a side view illustrating the discharge conveyor of the apparatus of FIG. 1.

FIG. 10 is a top view illustrating another portion of the discharge conveyor of the apparatus of FIG. 1.

FIG. 11 is a block diagram illustrating the cooperation between the various control systems of the apparatus of FIG. 1.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including,” “having,” and “comprising” and variations thereof herein is meant to encompass the items listed thereafter and equivalents thereof as well as additional items.

### DETAILED DESCRIPTION

The invention relates to an apparatus and method for combining and packaging different types of foodstuffs, such as appetizers. Appetizers are often bite-sized finger foods that may be served raw, cold, or heated, and may include a coating, such as a breading or batter coating. Some examples of typical appetizer foods that can be processed include mozzarella sticks, french fries, onion rings, battered or breaded vegetables (e.g., mushrooms, cauliflower, broccoli, zucchini), chicken strips, stuffed jalapenos, cheese curds, chicken wings, crab cakes, wing paddles, potato wedges, shrimp, etc. It is understood that the discussion of the use of the apparatus and associated method described herein with appetizers is not intended to be limiting and it is understood that the invention can be applied to any type of foodstuffs.

Appetizers are often sold to consumers in a restaurant-type setting in individual orders of a single type of appetizer. In some instances, the consumer might want to sample a variety of the different appetizers sold by that restaurant, but does not want to order individual orders of each type of appetizer. To satisfy these customers, many restaurants offer a sample platter containing a variety of different types of appetizers in smaller amounts so that the consumer can sample the different types of appetizers without the hassle and expense of ordering each type individually.

The apparatus and method of the invention described herein are used to produce individualized packages that contain a predetermined mix of different types of appetizers in a single overall serving so that the restaurants can better serve the needs of the consumers. The blend of the different types of appetizers included in the serving, along with the individual compositions of each type of appetizer, are chosen so that the entire serving can be heated together for a single cook time, while heating each individual type of appetizer such that each appetizer is cooked substantially to completion while ensuring a high quality product. As used herein, cooked substantially to completion is intended to mean that if the appetizers are served within an appropriate time after cooking, the appetizers are suitably warm for consumption by the consumer, and have other desired characteristics such as crispness, consistency, etc. that lead to a tasty, high-quality product.

Each type of appetizer may also have a predetermined characteristic so that the blend of appetizers can all cook together for a single period of time. For example, mozzarella sticks are a popular appetizer included in the single-serving blends. However, if the cheese is cooked for too long, the cheese can reach its boiling point and begin to bleed out of the product, resulting in a low quality product. In extreme cases, the coating around the cheese could also burn. Thus, the cheese cannot be cooked for extended periods of time. However, if the mozzarella sticks are included in a blend with another appetizer that requires a longer cook time to be cooked to completion, a compromise must be made to provide a single cook time solution. Thus, the composition of the mozzarella stick can vary depending on the blend. In some blends, a thicker mozzarella stick is used (for example, a 9/16 inch stick vs. a standard 7/16 inch stick—up to 29% thicker) to increase the allowable cook time of the cheese.

With other types of appetizers, such as cauliflower, the size of the pieces can be varied to facilitate a shorter cook time to be compatible with the cheese and other components of the blend. For example, the size of a single piece of cauliflower may be reduced from 2¼ inches to 1½ inches in maximum diameter. With still other appetizers, such as onion rings, a thicker piece of onion may be used to increase the cook time that the onion ring is able to withstand without degrading the quality of the product.

In other embodiments, the moisture content of the cheese can be varied to achieve the appropriate texture when cooked (up to 10% more moisture). In still other embodiments, the salt content of the cheese can be varied to increase or decrease the boiling point of the cheese. For example, the salt content of the cheddar cheese curds used in the blends may be varied from a range of 1.2% to 2.0% salt by weight, to a range of 2.0% to 3.0%.

Another characteristic of the appetizers that might be altered to allow for a single cook time of the different components is the coating on the appetizer. For example, the breading used one appetizer, such as a cheese curd, may be thicker than the breading used on another appetizer, such as a mushroom, to help protect the cheese curd against the extended cooking times. In other embodiments, the breading might be replaced altogether with a batter coating. Appetizers with batter coatings are pre-fried for a period of time before packaging such that the batter forms a protective shell that can withstand higher temperatures that would cause a breading coating to crack. However, the pre-frying process does not cook the foodstuff within the coating (i.e., after the pre-frying process, the food within the coating is still raw).

In still other embodiments, some types of the appetizers may be precooked such that they need only be reheated when heated in the restaurant. For example, the cook time required for an uncooked chicken strip is too long to combine it with other types of appetizers. By precooking the chicken strips before packaging, the chicken strips may be safely reheated within the acceptable time frames for cooking the other types of appetizers in the blend.

In some embodiments, the compositions of the different types of appetizers themselves can factor into determining what appetizers to include in a given blend. For example, components, such as chicken wings, need a longer cook time to ensure a product that is safe to eat. Other components, such as cheese curds, may not be able to be altered enough to allow both components to share the same cook time. In these embodiments, the blend itself is altered so that chicken wings and cheese curds are not included in the same blend.

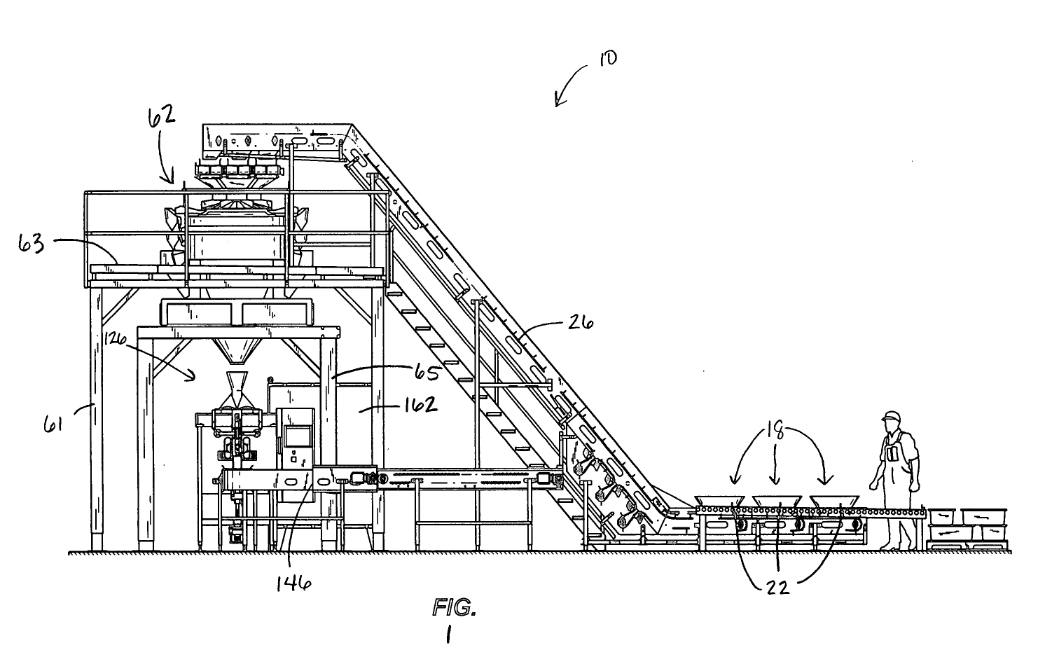

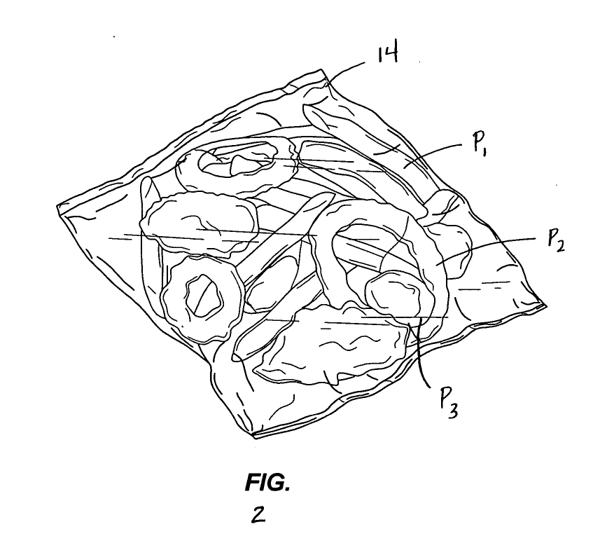

FIG. 1 illustrates an apparatus 10 that can be used to create a package, such as a bag 14. The bag 14 contains a single serving of a blend of different types of appetizers that can be heated for a single cook time while maintaining the quality of all the individual appetizer components. The bag 14 is best shown in FIG. 2 and includes a variety of different products P₁, P₂, P₃ in a single package. In the embodiment illustrated in FIG. 2, the product P₁ is a french fry, the product P₂ is an onion ring, and the product P₃ is a cheese curd. It is understood that the bag 14 could also contain one or more of the other different types of appetizers discussed above. All the components of the apparatus 10 are constructed to meet FDA and USDA equipment codes for sanitary food handling and packaging.

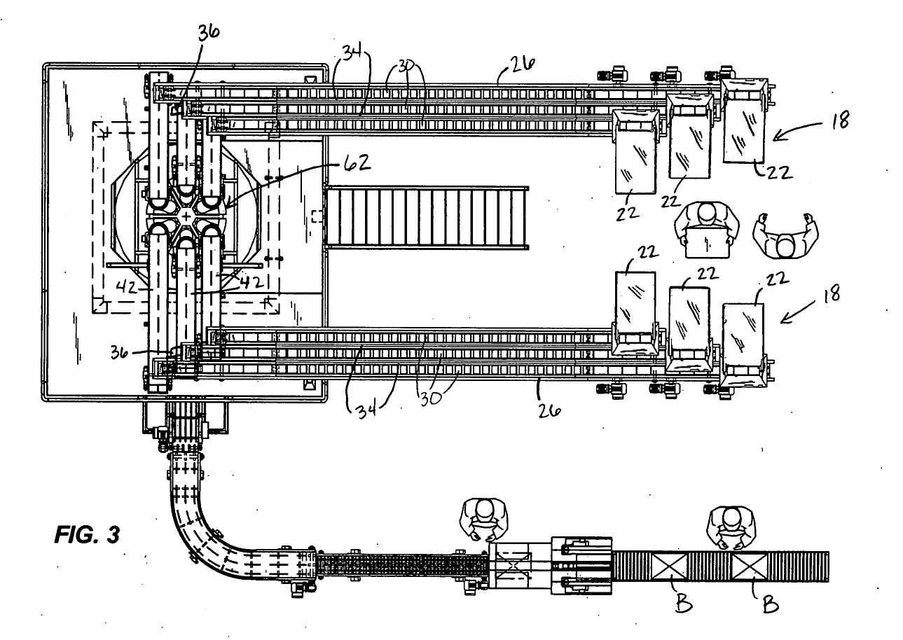

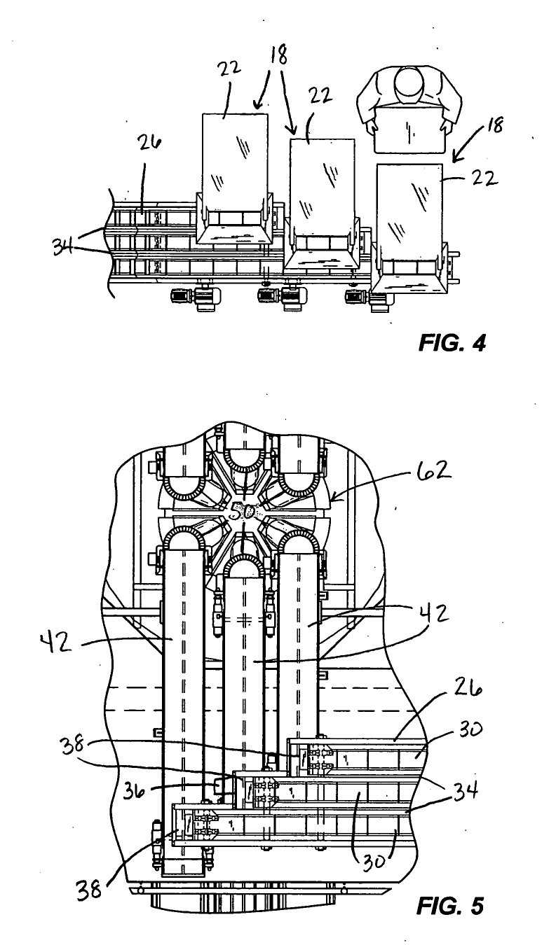

Referring to FIGS. 3 and 4, the apparatus 10 includes a plurality of loading stations 18 (six are shown in the illustrated embodiment) that each include a vibratory table 22, such as vibratory conveyor model number BFA-1236-350, available from Renalds of Westfield, N.Y., that is used to deliver product to one of two partitioned conveyors 26. In the illustrated embodiment, each of the six loading stations 18 can deliver a different product to the conveyors 26. However, it is understood that in other embodiments, two or more of the loading stations might deliver the same product to the conveyors or fewer than six loading stations might be used at one time. When all six loading stations 18 deliver a separate product to the conveyors 26, the resultant bag 14 would contain a blend of six different types of appetizers. However, it is understood that in other embodiments, a blend of anywhere between two and six different types of appetizers can be packaged.

The vibratory tables 22 include a control system that can vary the speed at which the table 22 vibrates, which controls the rate of product fed to the conveyors 26. Each vibratory table 22 rests on a vibratory support (not shown) and includes a control system 28 in communication with the control systems of other components of the apparatus 10.

The conveyors 26 of the illustrated embodiment are incline conveyors and each includes three lanes 30 for receiving one of a plurality of different products that make up the blend of the illustrated embodiment. The conveyors 26 include dividing walls 34 between the lanes to ensure that the different appetizers remain separated as they travel up the conveyors 26. A photoeye 36 adjacent each conveyor can send signals 40 to a conveyor control system 38 when no product is detected on the conveyors 26, which in turn can signal the vibratory tables 22 to vibrate faster to put more product on the conveyors 26. The conveyor control system 38 includes an incline conveyor control input 39 and a cross-feeder control input 41 in communication with each other. For the remainder of the discussion of the apparatus 10, the path of one type of foodstuff (e.g., mozzarella sticks) will be described for simplicity. It is understood that the other components of the blend travel through the apparatus in substantially the same manner as described for the mozzarella sticks.

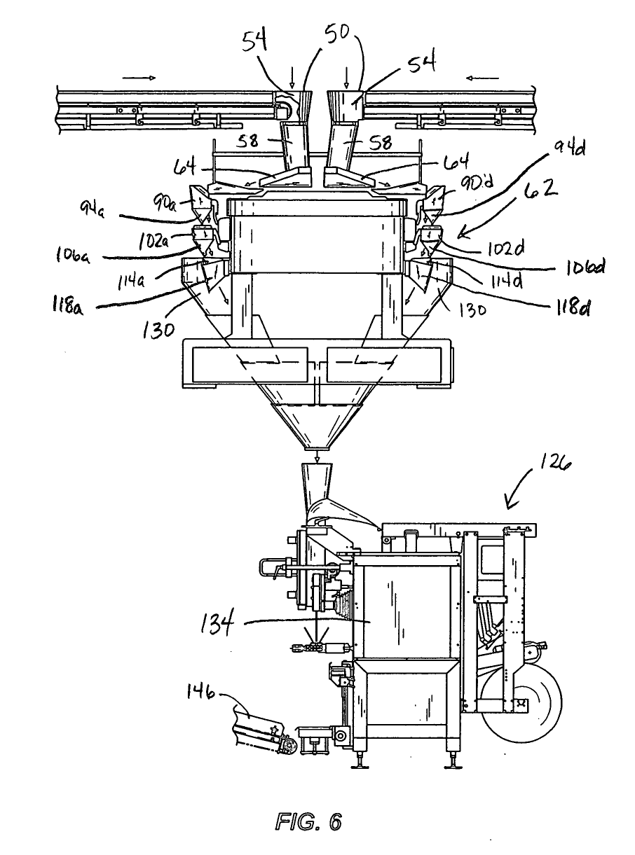

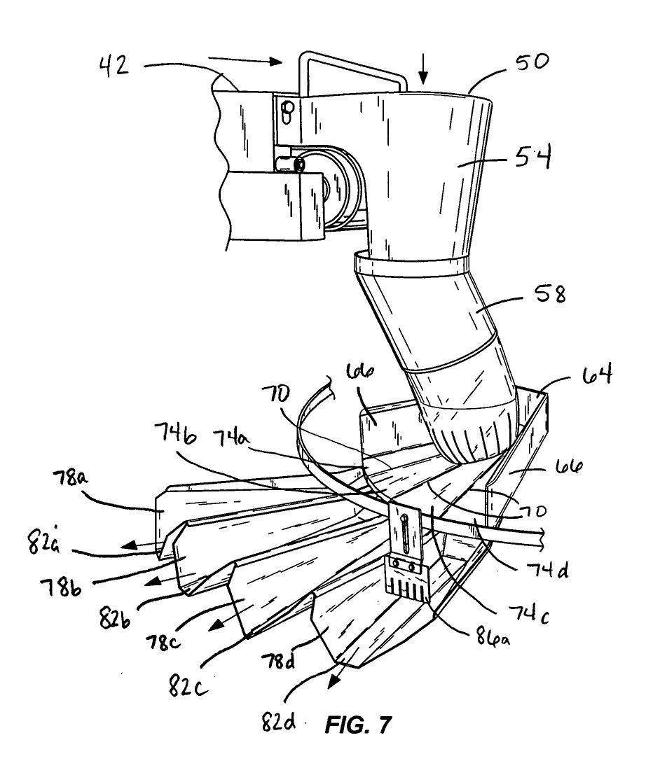

As shown in FIG. 5, the mozzarella sticks then travel through a nose portion 38 of the conveyor 26 onto a cross-feeding conveyor 42. Similar to the conveyors 26, each of the cross-feeding conveyors delivers each component of the blend separately to one of six transfer funnels 50. Each transfer funnel 50 includes an upper receiving portion 54 and a lower inclined portion 58 (best shown in FIGS. 6 and 7). The angle of the inclined portion 58 with respect to the vertical is chosen to maximize the speed at which the apparatus 10 can process the mozzarella sticks, as well as to preserve the integrity of the product. If the lower portion 58 had little or no incline with respect to the vertical, the mozzarella sticks would be transferred faster. However, the transfer would also be more forceful, and could result in damage to the mozzarella sticks. Thus, the angle of the inclined portion 58 is optimized for both speed and safe delivery.

The transfer funnel 50 delivers the mozzarella sticks to a scale assembly 62. The scale assembly 62 is a modified version of an Ishida six part blending scale, model number CCW-M-224B-6M/30-WP, available from Heat and Control of Chicago, Ill., with customizations made to the control system 60. The control system 60 includes a customized software package that receives signals from the scale assembly 62 indicating the weight of individual blend components, as well as a total overall weight for a package containing the individual blend components. With this information, the purchaser can know both the total weight (minimum predetermined overall weight) of the packaged blend, as well as the weight, by part, of each blend component (minimum predetermined component weights). The scale assembly 62, and its related control system 60, act as the central nervous system of the apparatus 10, with the control system 60 directing the other components of the apparatus 10 when to stop, when to start, and how fast to run, depending on the signals generated by the scale assembly 62. This relationship between the control systems of the individual components of the apparatus 10 will be discussed in greater detail below.

Referring back to FIG. 1, the scale assembly 62 includes a frame 61 that supports a mezzanine area 63 that allows a person to walk around the scale assembly 62 should the scale assembly 62, or the components that feed into the scale assembly 62, require adjustment. However, if the frame 61 supported the weight of the scale assembly 62, the measurements made by the scale assembly 62 could be adversely affected by the weight of a person standing on the mezzanine area 63. Thus, a separate support 65 supports the weight of the scale assembly 62.

The scale assembly 62, as illustrated in FIGS. 5 and 6, is comprised of six sections that correspond to the six transfer funnels 50. Each of the six sections is further subdivided into four quadrants, as will be described in more detail below, for a total of twenty-four subsections.

With reference to FIG. 7, the scale assembly 62 includes six disbursement tables 64 that each includes a pair of side rails 66 and three raised ribs 70 that together form four lanes 74a-d (the four quadrants of each of the six sections) within each disbursement table 64. Each disbursement table 64 is sloped 10° with respect to the horizontal to assist in moving the mozzarella sticks from the disbursement table 64 to the next station, the angle of slope being maximized for speed and product safety as discussed above with respect to the inclined portion 58 of the transfer funnels 50.

The disbursement table 64 is vibrated to feed the mozzarella sticks to radial feeders 78a-d associated with the lanes 74a-d of the disbursement table 64 from which the mozzarella sticks are transferred. The vibration is controlled by a disbursement table control, which is in communication with the scale control system 60 at the disbursement table control input 76. The disbursement table control input is also in communication with a radial feeder control input 80. The radial feeders 78a-d each have a trough 82a-d into which the products are funneled for transfer to the next station. As illustrated, the troughs 82a-d are sized and configured such that they are able to transfer various different products, because while the troughs 82a-d accept mozzarella sticks in one blend, in other blends the same troughs 82a-d may accept chicken wings or other products and thus need to be sized and configured accordingly. The troughs 82a-d are also sized and configured to control the rate in which the mozzarella sticks pass along the feeders 78a-d. Depending on which lane 74a-d of the disbursement table 64 that the sticks fall from, they move at a different rate down the radial feeders 78a-d. The troughs 82a-d are sized and configured to slow the rate of the sticks in some of the feeders (e.g., the narrower, v-shaped trough 82b) and increase the rate of movement in others (e.g., the wider, u-shaped trough 82a), depending on how the sticks fall off of the disbursement table 64.

The radial feeders 78a-d also include product diverters 86a-d (only one shown in FIG. 7) that prevent the mozzarella sticks in radial feeder 78a from jumping into radial feeder 78b to prevent cross-contamination of the appetizer components. The radial feeders 78a-d are sloped with respect to the horizontal, the slope angle being maximized for speed and product safety. The mozzarella sticks are moved along the radial feeders 78a-d due to gravity pulling the sticks down the sloped surface. The radial feeders 78a-d are also vibrated to control the rate of movement of the mozzarella sticks down the feeders, the vibration controlled by a radial feeder control in communication with the scale control system 60 at the radial feeder control input 80.

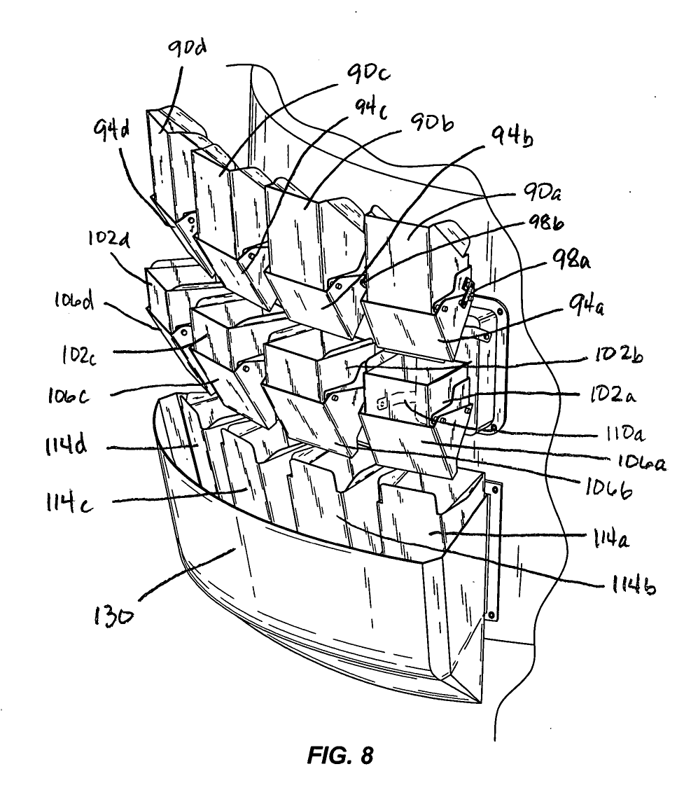

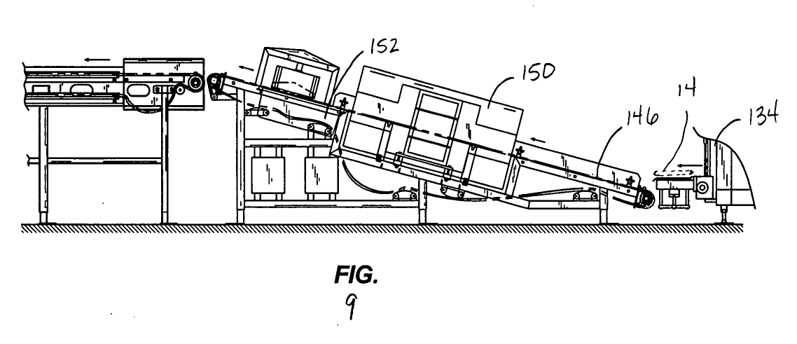

With reference now to FIG. 8, the mozzarella sticks are fed from the radial feeders 78a-d to pooling hoppers 90a-d. The pooling hoppers 90a-d collect the mozzarella sticks and include a movable bottom 94a-d. Each of the hoppers 90a-d includes a control system in communication with the scale control system 60 at the pooling hopper control input 96 that actuates a motor (not shown) to move an arm assembly 98a-d (only two shown in FIG. 8) to open the bottom 94a-d to allow the mozzarella sticks to pass through.

The mozzarella sticks move through the hoppers 90a-d into weighing buckets 102a-d. Similar to the pooling hoppers 90a-d, the weighing buckets 102a-d have a movable bottom 106a-d actuated by a motor driving an arm assembly 110a-d (only one shown in shadow in FIG. 8). It is in the weighing buckets 102a-dthat the scale assembly 62 weighs the mozzarella sticks. When mozzarella sticks are deposited in the weighing buckets 102a-d, the software of the control system 60 for the scale assembly 62 sends a weight signal 104 to the control system, indicating the weight of each bucket 102a-d. Once the weights of the buckets 102a-d are received by the control system 60, the control system 60 selectively triggers the motor to drive the arm assembly 110a-d to open the bottoms 106a-d by sending a signal to the weighing bucket control input 112, as will be further described below.

From the weighing buckets 102a-d, the mozzarella sticks take one of two paths. Sometimes, the mozzarella sticks will be deposited into collection hoppers 114a-d. This will most likely happen when the weight of the mozzarella sticks in an individual bucket 102a, for example, does not equal or exceed the minimum predetermined component weight of mozzarella sticks for the product blend that is being produced. The mozzarella sticks may also be deposited into the collection hoppers 114a-d if it is not yet time to send the mozzarella sticks to the packaging station 126. The collection hoppers 114a-d can store a weighed portion of the mozzarella sticks, and similar to the weighing buckets 102a-d, have a movable bottom 118a-d (shown in FIG. 6) actuated by an arm assembly (not shown but substantially similar to the arm assembly 98a-d of the pooling hoppers 90a-d). The arm assembly is controlled by the collection hopper control, which is in communication with the scale control system at collection hopper control input 124.

Other times, in instances when the weight of the mozzarella sticks in an individual bucket 102a is equal to or slightly exceeds the minimum predetermined component weight of mozzarella sticks for the product blend, the mozzarella sticks may pass from the bucket 102a, through an empty underlying collection hopper 114a, to the packaging station 126 without first coming to rest in the collection hopper 114a. The motors for the bucket 102a and collection hopper 114a will act in tandem to actuate both the movable bottoms 106a, 118a to allow the mozzarella sticks to pass directly through the collection hopper 114a.

When the control system of the scale assembly 62 receives weight signals from all sections containing different types of appetizers, indicating that the different types of appetizers are properly weighed for packaging, the control system will actuate each of the sections to cause the appropriate bottoms 106a-d, 118a-d in each section to dump like products (e.g., mozzarella sticks) from one or a combination of the buckets 102a-d and hoppers 114a-d. In some cases, as discussed above, the minimum predetermined component weight will be found in a single weight bucket 102a, and the mozzarella sticks will pass through the collection hopper 114a. In other cases, the minimum predetermined weight will be found in a single collection hopper 114b, and the mozzarella sticks will be dumped from that single hopper. In yet other cases, the minimum predetermined weight will be found in some combination of buckets 102a-d and hoppers 114a-d. In these cases, the scale control system 60 will trigger the appropriate collection hopper and weight bucket controls to release the mozzarella sticks from the appropriate containers.

Once the mozzarella sticks and other appetizers for the blend exit the collection hoppers 114, they are delivered to a packaging station 126 (shown in FIG. 6) by a discharge chute 130. As with many of the other components discussed above, the discharge chute 130 is angled with respect to the vertical and the angle is chosen to maximize product delivery speed while maintaining product quality. Delivering the product too fast to the packaging station could result not only in damage to the appetizers, but also damage to the packaging used to house the blend.

The packaging station 126 of the illustrated embodiment includes an Icon 380 bagging machine 134, sold by CMD Packaging of Green Bay, Wis., that produces a non-segmented bag 14 (illustrated in FIG. 2) of finished product. It is understood that in other embodiments, the single-serving of the desired blend could be packaged in other containers, such as a box.

The packaging station 126 includes a packaging station control system 128 in communication with the scale control system 60, such that weight signals 104 received by the scale control system 60 can tell the packaging station control system 128 when to activate the bagging machine 134. A thermal transfer printer, available from Markem of Keene, N.H., applies the date code, product name, and cooking directions to the bag 14 containing the desired blend.

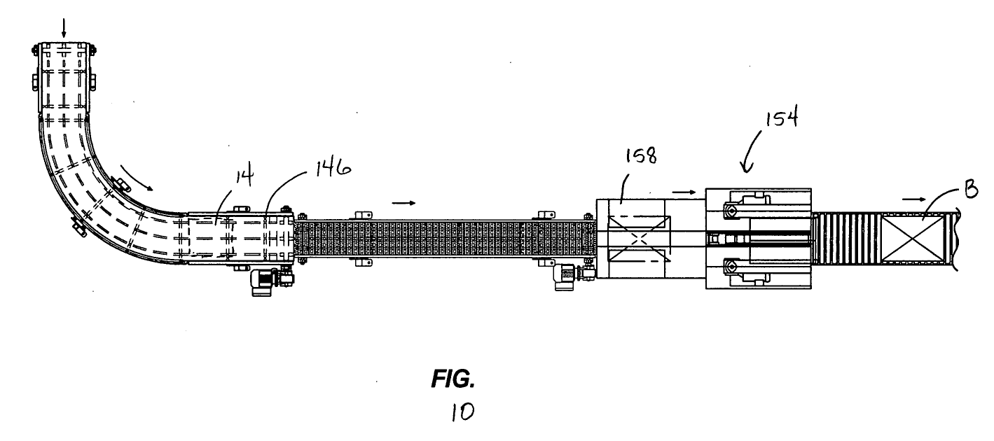

As shown in FIG. 9, the bag 14 is discharged from the bagging machine 134 onto a discharge conveyor 146 controlled by a discharge conveyor control system 148 in communication with the packaging station control system 128 to a dual discharge incline metal detector 150 that includes a Cintex Sentry 2300 head. The metal detector 150 is controlled by a metal detection control system 152 in communication with the discharge conveyor control system 148 and measures the density of the product within the bag 14. If the density falls outside of the appropriate parameters, the bag 14 is discharged off of the conveyor 146 into a storage bin 152.

If the density falls within the appropriate parameters, the bag 14 continues along the conveyor 146 to a packing station 154, best shown in FIG. 10. The packing station 154 includes a Pack-Mate box erector 158, available from SOCO System of Waukesha, Wis., that erects boxes to accept the bags 14 of the desired blend. The box erector 158 is controlled by the packaging station control system 160 in communication with the metal detector control system 152. A taping machine, model number LD-7D, available from Little David of South Canaan, Pa., tapes the boxes full when a full case of bags 14 has been filled. A Lincoln case printer, model number 3076, code dates each box. A Data Max Labeler, model number DMX-I-4206 prints and applies labels to each box, which is now ready for shipping. When the apparatus 10 is running at optimal levels, between forty and fifty bags of a desired blend can be produced per minute.

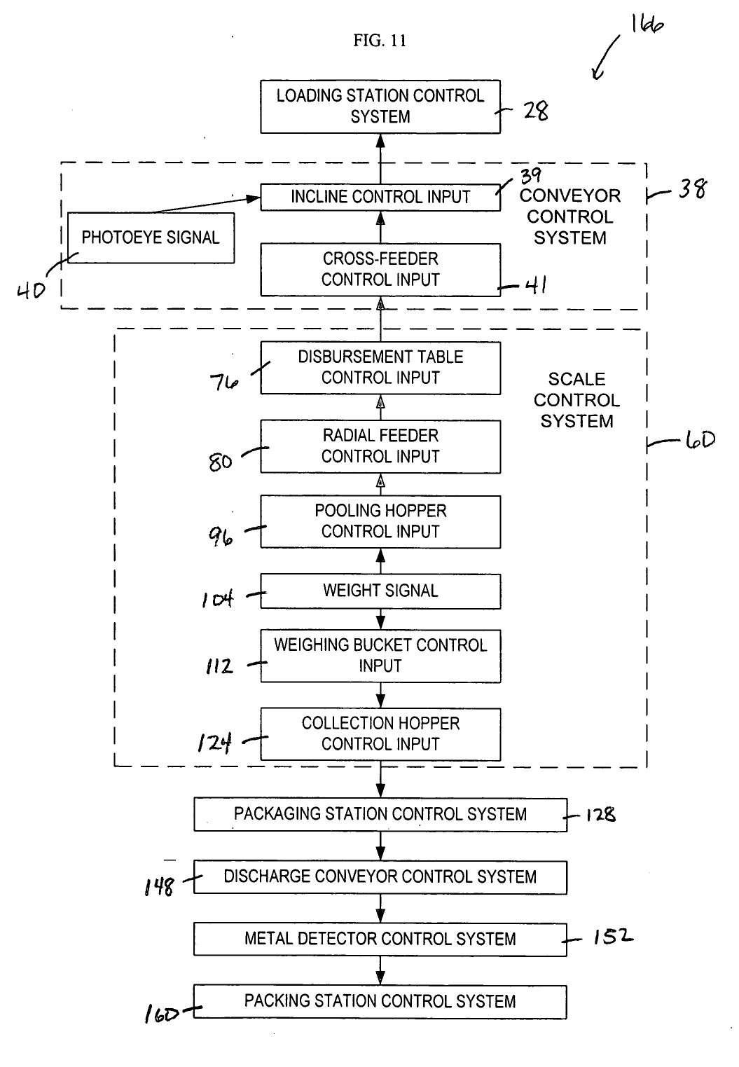

The apparatus 10 also includes a control box 162 attached to a surface near the apparatus 10, illustrated in FIG. 1. The control box 162 houses the controllers and processors needed to control the apparatus, including the controllers for the individual components discussed above. With reference to FIG. 11, the apparatus 10 includes a control package 166 that integrates the individual controllers together for control of the product from start to finish, with individual component control for each piece of equipment. The control package is centered around the control system 60 of the scale assembly 62.

The control of the system works in two directions from the scale assembly 62 based on the weight signals 104 from the four quadrants of each of the six sections. If the weight of the product is too little or too much, the control package signals the pooling hopper control to actuate the bottom 94a-d of the pooling hoppers 90a-d. If the required amount of product is not available in the pooling hoppers 90a-d, the pooling hopper control system signals the vibratory radial feeders 78a-d and disbursement table 64 to vibrate at a faster or slower rate, depending on whether the scale assembly 62 indicates that more or less product is required. This signal in turn signals the controls for the cross-feeding conveyors 42 and/or the incline conveyors 26 to start, stop, or change the rate of travel accordingly, to adjust the amount of product entering the scale assembly 62. This in turn signals the vibratory tables 22 to start, stop, or change the rate of the vibratory motion so that the desired amount of product is placed on the conveyors 26.

The scale assembly 62 control system also controls the components in the path downstream of the scale assembly 62. The scale assembly 62 triggers the individual controls of the weighing buckets 102a-d and collection hoppers 114a-d to release product to the packaging station 126 in appropriate combinations to provide the minimum predetermined component weight of each component of the blend. This, in turn, triggers the bagging machine 134 to form a bag 14 of a single serving of the blend and move that bag 14 onto the discharge conveyor 146. The discharge conveyor 146 signals the metal detector control system 152 to scan the bag 14. If the density of the product in the bag 14 is correct, the bag 14 continues on the discharge conveyor 146, which sends a signal to the packaging station control system 160. This, in turn, causes the box erector 158 to erect a box to ready a case of single serving bags 14 for shipping.

The apparatus 10 can be used to perform a method of packaging foodstuffs. The first lane 30 of the first conveyor 26 delivers a quantity of a first foodstuff, such as mozzarella sticks, to a weighing area, such as the scale assembly 62. The first lane 30 of the second conveyor 26 delivers a quantity of a second foodstuff, such as onion rings, to a different portion of the scale assembly 62. In the illustrated embodiment, up to six different foodstuffs, such as cauliflower, broccoli, mushrooms, mozzarella sticks, onion rings, and cheese curds, may be delivered to the weighing area and packaged together by the apparatus 10. In other embodiments, fewer or more than six different foodstuffs may be blended in one package.

The control system of the scale assembly 62 is capable of weighing the different foodstuffs both individually, and together. The scale assembly 62 delivers the foodstuffs to a packaging station, such as the bagging machine 154, to form a single package that has a minimum predetermined overall weight and a minimum predetermined weight of each of the individual foodstuffs.

One or more of the different foodstuffs may also have different predetermined characteristics to allow the different types of foodstuffs to be cooked together for the same amount of time. The predetermined characteristics may include increased or decreased size, increased or decreased salt content, varied moisture content, or different coatings, among other things.

The resulting packages of blended appetizers may then be shipped to restaurants and other food service locations. Previously, when a cook at a restaurant wanted to create an appetizer sampler, the cook had to go to multiple bins or packages to get the various products, estimate how much of each product to include in the blend to ensure profitability, and then cook the components separately and for different periods of time to ensure that all the components were cooked to completion. Now, the cook needs only remove a single package containing all the components in premeasured amounts to ensure profitability, dump the contents of the package into a cooking device, such as a deep frier which heats the food in hot oil, and heat all the products together for a single period of time. The cook can be confident that all the components are cooked to completion without degrading the quality of any of the individual components. It is understood that in other embodiments, the appetizers or other foodstuffs could be heated while still in the package, such as within an oven or by boiling in water, and still fall within the scope of the present invention.

One particular blend created by the apparatus 10 is the Wisconsin Veggie™ blend, available from Shareholder™ Brands, LLC of Two Rivers, Wis. The Wisconsin Veggie™ blend includes a six-component mix of battered cheesy cauliflower, battered cheesy broccoli, battered mushrooms, battered mozzarella sticks, battered onion rings, and Cheddar Snaps™. A single-serving package of the Wisconsin Veggie™ blend is 14.2 ounces in total weight, and includes 2.22 ounces of the cauliflower, 2.5 ounces of the broccoli, 2.53 ounces of the mushrooms, 1.75 ounces of the Cheddar Snaps™, 2.0 ounces of the mozzarella sticks, and 3.2 ounces of the onion rings. Nothing in the Wisconsin Veggie™ blend is precooked before packaging.

Any number of product blends are possible using the above-described apparatus and method. Other blends available from Shareholder™ Brands of Two Rivers, Wis. include East Coast™ blend, Tavern MiX™, Party Cheese™, Bourbon Street Brand™, Nest & Net™, Brew House™, and Wings & Things™, among others.

The East Coast™ blend has a total overall weight of 15.0 ounces and includes battered onion petals, battered mozzarella sticks, battered mushrooms, breaded zucchini slices, and crab cakes. The Tavern MiX™ blend has a total overall weight of 16 ounces and includes cream cheese jalapenos, battered mozzarella sticks, Cheddar Snaps™, battered onion rings, battered mushrooms, and french fries. The Party Cheese™ blend has a total overall weight of 12.8 ounces and includes battered provolone cheese sticks, battered mozzarella sticks, Cheddar Snaps™, battered homestyle cheese curds, and battered onion rings. The Bourbon Street Brand™ blend has a total overall weight of 15.5 ounces and includes buffalo style chicken wings, battered onion rings, potato wedges, lemon cream cheese stuffed jalapenos, and beer battered mushrooms. The Nest & Net™ blend has a total overall weight of 16.3 ounces and includes crab cakes, popcorn shrimp, french fries, battered mozzarella sticks, chicken strips, and Cheddar Snaps™. The Brew House™ blend includes a total overall weight of 12.5 ounces and includes beer battered onion rings, beer battered mozzarella sticks, cream cheese stuffed jalapenos, beer battered shrimp, chicken strips, and beer battered mushrooms. The Wings & Things™ blend has a total overall weight of 17.4 ounces and includes wing paddles, cream cheese stuffed jalapenos, battered onion rings, battered mushrooms, and french fries.

Various features of the invention are set forth in the following claims.

1. A package of foodstuffs having a minimum predetermined overall weight, the package comprising:
a first foodstuff having a first composition and a first minimum predetermined component weight; and
a second foodstuff having a second composition and a second minimum predetermined component weight;
wherein the first and second foodstuffs are designed to be cooked together for a single cooking time such that the first and second foodstuffs each are cooked substantially to completion without degrading the quality of the first and second foodstuffs.

2. The package of claim 1, wherein the foodstuffs are appetizers.

3. The package of claim 1, wherein the first and second foodstuffs are designed to be cooked in hot oil.

4. The package of claim 1, wherein the package is non-segmented such that the first and second foodstuffs are commingled within the package.

5. The package of claim 1, wherein the first foodstuff also has a first predetermined characteristic, and wherein the second foodstuff has a second predetermined characteristic, the first and second predetermined characteristics allowing the first and second foodstuffs to be cooked together for the single cooking time.

6. The package of claim 5, wherein the first and second predetermined characteristics may be the same characteristic.

7. The package of claim 5, wherein the first and second predetermined characteristics are one of varied salt content, varied size, varied moisture content, and varied coating.

8. The package of claim 1, wherein neither the first nor second foodstuffs are precooked.

9. The package of claim 1, wherein the first and second minimum predetermined component weights are different from each other.

10. The package of claim 1, further comprising up to four additional foodstuffs having different compositions, wherein the up to four additional foodstuffs are also designed to be cooked together for the single cooking time.

11. A method of packaging foodstuffs, the method comprising:
delivering a first quantity of a first foodstuff to a weighing area, the first foodstuff having a first composition;
delivering a second quantity of a second foodstuff to the weighing area, the second foodstuff having a second composition different from the first composition;
weighing the first and second foodstuffs individually and in combination; and
placing the first and second foodstuffs in a single package such that the single package has a minimum predetermined overall weight, a minimum predetermined component weight of the first foodstuff, and a minimum predetermined component weight of the second foodstuff.

12. The method of claim 11, further comprising labeling the package with a single cook time for both the first and second foodstuffs that will allow both the first and second foodstuffs to be cooked substantially to completion without degrading the quality of the first and second foodstuffs.

13. The method of claim 11, wherein the act of delivering includes delivering quantities of more than two different foodstuffs to the weighing area.

14. The method of claim 11, wherein delivering the first and second foodstuffs further includes delivering first and second foodstuffs having first and second predetermined characteristics, respectively, that allow the first and second foodstuffs to be cooked together for a single length of time such that the first and second foodstuffs are cooked substantially to completion while maintaining the quality of both the first and second foodstuffs.

15. The method of claim 11, wherein weighing the first and second foodstuffs includes sending respective first and second weight signals to a control system, the control system capable of comparing the first weight signal to the minimum predetermined component weight of the first foodstuff, comparing the second weight signal to the minimum predetermined component weight of the second foodstuff, and combining the first and second weight signals and comparing the combined first and second weight signals to the minimum predetermined overall weight to place the proper amounts of the first and second foodstuffs in the package.

16. A method for preparing foodstuffs for consumption, the method comprising:
providing a package containing a single serving of foodstuffs, the foodstuffs including a plurality of different types of foodstuffs having different compositions, the package having a minimum predetermined overall weight and a minimum predetermined component weight of each of the plurality of different types of foodstuffs;
placing the foodstuffs in a cooking device; and
cooking the single serving of foodstuffs together for a single cooking time such that all of the different types of foodstuffs are cooked substantially to completion while maintaining the quality of the foodstuffs.

17. The method of claim 16, wherein providing a package includes providing a non-segmented package so that the plurality of different types of foodstuffs are commingled within the package.

18. The method of claim 16, wherein providing a package containing a single serving of different types of foodstuffs includes providing a plurality of foodstuffs having different predetermined characteristics to facilitate cooking the plurality of foodstuffs for the single cooking time.

19. The method of claim 18, wherein providing a plurality of foodstuffs having different predetermined characteristics includes providing foodstuffs having one of varied salt content, varied size, varied moisture content, and varied coating.

20. The method of claim 16, wherein cooking the single serving of foodstuffs includes cooking the foodstuffs in hot oil.

21. The method of claim 16, further comprising removing the foodstuffs from the package

22. An apparatus for combining and packaging different types of foodstuffs, the apparatus comprising:
a plurality of loading stations;
a conveyor in communication with the loading stations;
a scale assembly in communication with the conveyor, the scale assembly including
a plurality of weighing mechanisms for weighing the different types of foodstuffs individually to achieve minimum predetermined component weights for each of the different types of foodstuffs, and
a control system operable to combine the minimum predetermined component weights of the different types of foodstuffs to achieve a minimum predetermined overall weight; and
a packaging station in communication with the scale assembly for receiving and packaging the weighed foodstuffs.

23. The apparatus of claim 22, wherein the loading stations each include a vibratory table.

24. The apparatus of claim 22, wherein the weighing mechanism includes a plurality of buckets that release the foodstuffs to the packaging station.

25. The apparatus of claim 24, wherein the control system can identify the individual weights within each bucket, and wherein the control system chooses one or more buckets to open to release the foodstuffs to the packaging station.

26. The apparatus of claim 22, wherein each of the components of the apparatus include a separate control system, and wherein the separate control systems of the individual components are in communication with each other.
